(19) United States
(12) Patent Application Publication
(10) Pub. No.: US 2015/0231017 A1
(43) Pub. Date: Aug. 20, 2015

(54) EQUIPMENT FOR TREATING AND CARING FOR THE SPINAL COLUMN

(71) Applicant: KAZEMI BACK HEALTH SL., Cabanillas del Campo - Guadalajara (ES)

(72) Inventor: Alireza Kazemi Banyhashemi, Horche-Guadalajara (ES)

(21) Appl. No.: 14/432,294

(22) PCT Filed: Sep. 23, 2013
(86) PCT No.: PCT/ES2013/070660

§ 371 Date: Mar. 30, 2015

(30) Foreign Application Priority Data
Sep. 28, 2012 (ES) P201231500

(51) Int. Cl. A61H 1/02

(52) U.S. Cl. CPC A61H 1/0292

(57) ABSTRACT

The invention concerns therapeutic equipment for treating and caring for the spinal column, the equipment comprising: a support frame (1); a seat for the patient to be treated, the seat position being orientable and adjustable; means for controlling the spinal column which consist of segments (19 to 24); adjustable means for supporting the legs and feet; adjustable traction and support means for the arms; and a force-transmission circuit consisting of a flexible cable (49).

### FIELD OF THE INVENTION

The present invention relates to a piece of equipment designed to care for the spinal column, which makes it possible to carry out preventative and therapeutic tasks with which to combat pain originating in the spinal column with maximum efficacy.

The invention aims to provide a piece of equipment which, in order to achieve its aims, incorporates the concepts of biomechanics, force, flexibility, neurodynamics, structural and functional re-adaptation and indirectly, activation of the local metabolism and redistribution of nociceptive substances through movement and indirect cellular activation, such that it makes it possible to successfully prevent and treat pain originating in the spinal column.

The piece of equipment object of the invention may be said to synchronously and consecutively submit the body to a series of movements based on a series of positions that achieve the results sought when the body undergoes various preventative and therapeutic techniques and methods, such as movements, stretches, neurodynamic exercises, strength exercises and flexibility exercises, etc., which in turn serve to eliminate the adverse effects of segmental spine sensitization theories relative to the presence of harmful substances, etc.

### BACKGROUND OF THE INVENTION

Appliances designed to improve the condition of certain parts of the body already exist, as do appliances designed to improve the spinal column. However, whilst these appliances act on the different areas of the body to be treated, they do not link other body parts or limbs with which clear links have been established, for example given that they come together to produce actions in order to improve the efficacy of the action sought.

Patents US2012/0058869, US2011/0237406 and US7717870 may be cited as example background documents in this sense.

None of these background documents concern equipment that facilitates the effective treatment of spinal column pain, which involve moving the extremities in order to synchronously and consecutively submit the body to different preventative and therapeutic techniques and methods.

### DESCRIPTION OF THE INVENTION

The present invention relates to a piece of equipment that makes it possible to induce movement in the spinal column based on a certain position pre-selected according to the level of injury, intensity of pain and alterations in posture. These movements are all consecutive in the body and as a result, are reflected along the spinal column whilst involving movement of the extremities, submitting both the spinal column and the body in general to a series of movements and forces, such that, in addition to spinal disc pressure-decompression treatment and the traction and distraction of soft tissues (muscles, tendons, ligaments, fascias and nerves, etc.,), general movement improves articular physiology and activates muscular contraction/relaxation, which in turn produces traction on the origin and the insertion of said soft tissues, thereby improving articular physiology and local metabolism.

The piece of equipment object of the invention is made up of a support frame; a seat, the position and orientation of which may be adjusted to the user or patient to be treated; means for controlling the posture of the body and of the spinal column; adjustable support means for the legs and feet, traction/distraction means and adjustable support means for the arms; in addition to a force-transmission circuit made up of a flexible cable, chain or rope, which links the seat to a lower support structure via two-way support pulleys. In addition, the equipment comprises controlled support means for the feet and legs, which are controlled by means of a spring system or pneumatic resistance system. The seat would preferably be similar in shape to that of a saddle.

The lower support structure is C-shaped with a lower horizontal stretch, which defines the support base of the assembly, in addition to a central vertical stretch and an upper horizontal stretch, which runs in a cantilevered manner above the lower horizontal stretch, parallel to the same.

The means for controlling the posture of the body and spinal column are suspended from the upper horizontal stretch, alongside the traction/distraction means and the adjustable arm support means. A vertical column is mounted to the lower horizontal stretch, so as to support the seat and the adjustable support means for the legs and feet.

The means for controlling the body's posture and the spinal column are made up of frontal and rear segments, which come together to form a series of orthoses in the form of a thoracic corset, an abdominal-lumbar girdle and a cervical collar, all of which may be adjusted and adapted to the patient's core. In a preferred embodiment, the means for controlling the body's posture and the spinal column comprise three frontal segments and three rear segments, which are arranged opposite one another and are interconnected by adjustable elastic fastening means. The rear segments are fastened to supports by means of horizontal axis joints and elastic supports. These supports are in turn mounted to a first auxiliary column, which is suspended from the upper horizontal stretch of the frame, in a position that may be adjusted along the length of said stretch.

The adjustable support means for the legs and feet comprise two upper horizontal supports, which are aligned with one another and serve to support the legs, the same being mounted to the column that supports the seat; and two lower footrests, the position of which may be adjusted, the same being suspended from the upper supports.

In turn, the arm traction and support means consist of an upper crossbar, which has adjustable end handles and lower arm rests, the position of which may also be adjusted and which are provided with a front grip. Just like the segments that form the corset, the lower armrests are mounted to the abovementioned auxiliary column.

The three rear segments and three frontal segments that make up the corset are grouped into pairs, thus forming an upper pair to be coupled to the neck, a central pair to be coupled to the back and thorax and a lower pair to be coupled to the abdomen and lumbar area. The two segments that form the lower pair are linked to the seat via elastic support elements.

A horizontal profile is mounted crosswise to the first auxiliary column, suspended from the upper horizontal stretch of the frame, it being possible to adjust the height of this horizontal profile, upon which the armrests are mounted, it being possible to move the same along the length of said profile.

The upper crossbar with handles is suspended from the upper horizontal stretch of the frame by means of a second auxiliary column, the position of which may be adjusted along the length of said stretch, to which two head-pieces that may be adjusted in height are mounted, the same being linked to one another by means of an elastic suspension spring, the lower head-piece serving to bear the upper crossbar, from the ends of which the handles are hung by means of ropes, the length of which may be adjusted elastically.

The lower horizontal stretch of the lower support structure is equipped with crosswise end extensions, in turn provided with support feet, designed to form the support base of the assembly.

The column used to mount the seat to the lower horizontal stretch of the frame may be adjusted in height and position along the length of said horizontal stretch.

According to one possible embodiment, the seat may by mounted to the column by means of a cart, which includes two perpendicular joint axes, one of which is longitudinal and the other, crosswise, in order to orient the seat. The cart may additionally be provided with means for adjusting the position of the seat along the length of the longitudinal joint axis.

According to an alternative embodiment, the cart supporting the seat may be mounted to the vertical column by means of a ball joint, which makes it possible to tilt the seat in any direction, including means for adjusting tilt resistance and means for locking the ball joint in any position selected on the cart.

The horizontal profile suspended from the upper stretch of the frame bears two front perpendicular arms, with one being located on each side of the first auxiliary column, it being possible to adjust the position of these arms along the length of the horizontal profile. A cart with an armrest is mounted to each arm. These carts are placed in an adjustable position along the length of the arms and the armrests are linked to the carts by means of elastic supports.

The upper horizontal supports are made up of several other horizontal bars, which are aligned and mounted to the front portion of the cart supporting the seat. Each bar bears a pillow to support one leg, in addition to as a flat lower support structure, which can tilt around the bar, to which two rungs that can be moved along the length of the frame are mounted: one upper rung with means for fastening to the frame and another lower rung, which is linked to the upper stretch via elastic suspension means. The lower rung has a tilting footrest mounted to it by means of a horizontal tilting axis and may be locked in position. The upper supports are equipped with means for locking the flat lower support structures to the horizontal bars to which they are mounted.

The force-transmission circuit is made up of a flexible rope, cable or chain, the ends of which are fastened to the seat and run and are driven over free rotation pulleys mounted to the lower support structure and foot rest. This force transmission circuit may include an inertia flywheel that can rotate freely, the axis of which is located on the plane defined by the support frame and which serves to bear a pulley through which the cable of said circuit passes.

### BRIEF DESCRIPTION OF THE DRAWINGS

The drawings attached provide a non-limiting, exemplary representation of a piece of therapeutic and preventative equipment for treating and caring for the spinal column, the same having been constructed according to the invention. In the drawings:

FIG. 1 provides a perspective rear view of the therapeutic equipment.

FIG. 2 provides a perspective front view of the same equipment.

FIG. 3 provides a side elevation view of the equipment shown in FIGS. 1 and 2.

FIG. 4 provides a front elevation view of the equipment shown in FIGS. 1 and 2.

FIG. 5 provides a rear elevation view of the same equipment.

FIG. 6 provides an upper plan view of the equipment object of the invention.

FIG. 7 provides a front elevation view according to direction A shown in FIG. 3, corresponding to the lower portion of the equipment.

FIGS. 8 and 9 provide respective side elevation and perspective views of the portion of the equipment shown in FIG. 7.

FIG. 10 provides a partial front elevation view of the equipment, viewed according to the cut line X-X- shown in FIG. 3.

FIG. 11 provides a side elevation view of the same portion of the equipment shown in FIG. 10.

FIG. 12 provides a side elevation view of the means for controlling the spinal column, which come to form part of the equipment object of the invention.

FIG. 13 provides a partial front elevation view of the equipment, viewed according to the cut line XIII-XIII- shown in FIG. 3.

### DETAILED DESCRIPTION OF ONE EMBODIMENT

The way in which the piece of equipment object of the invention is built and functions shall be made clearer in the description below, as shall the characteristics and advantages derived from the same. This description refers to the exemplary embodiment shown in the drawings attached.

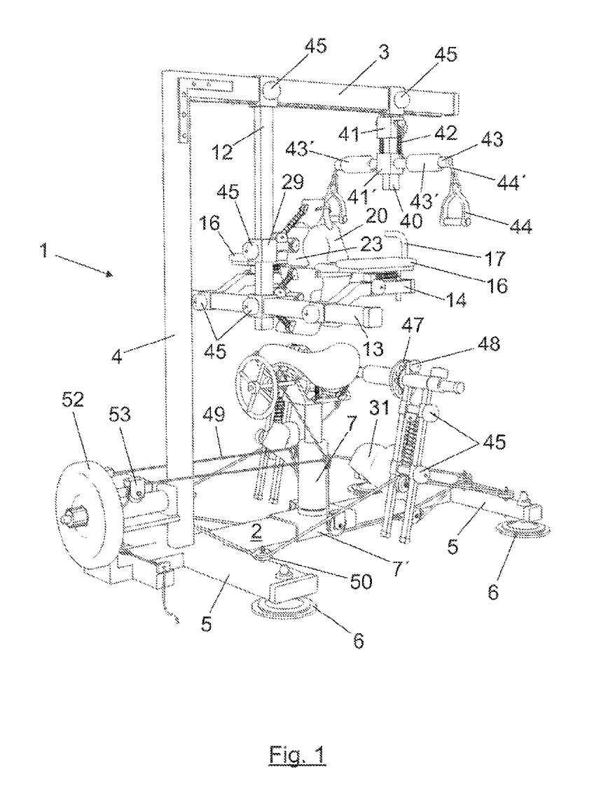

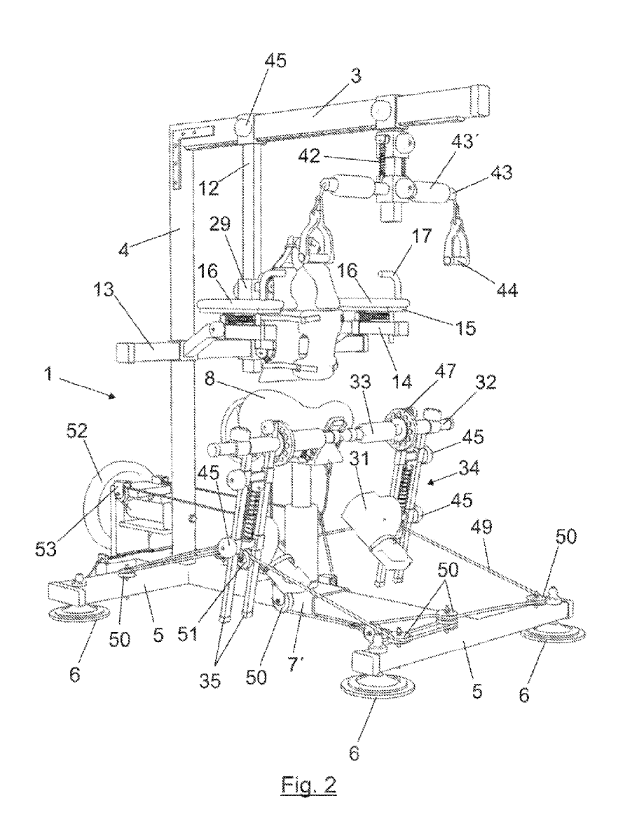

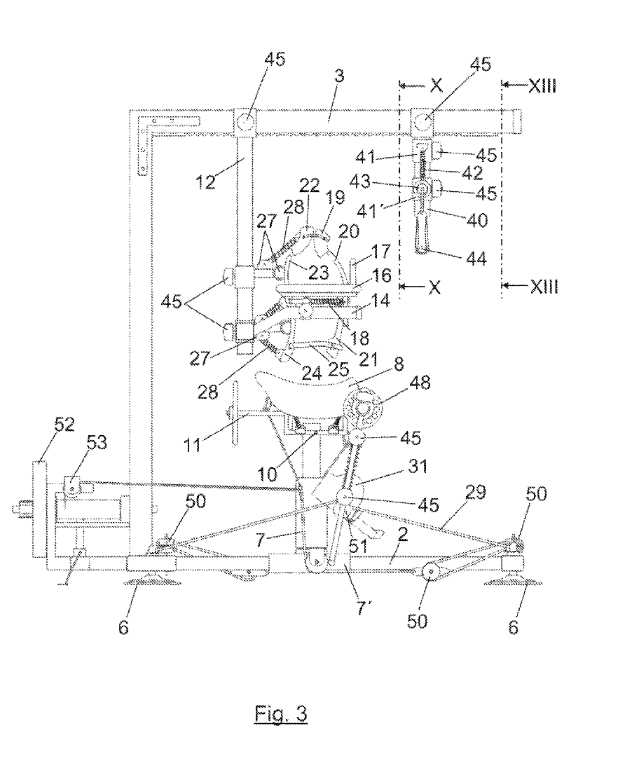

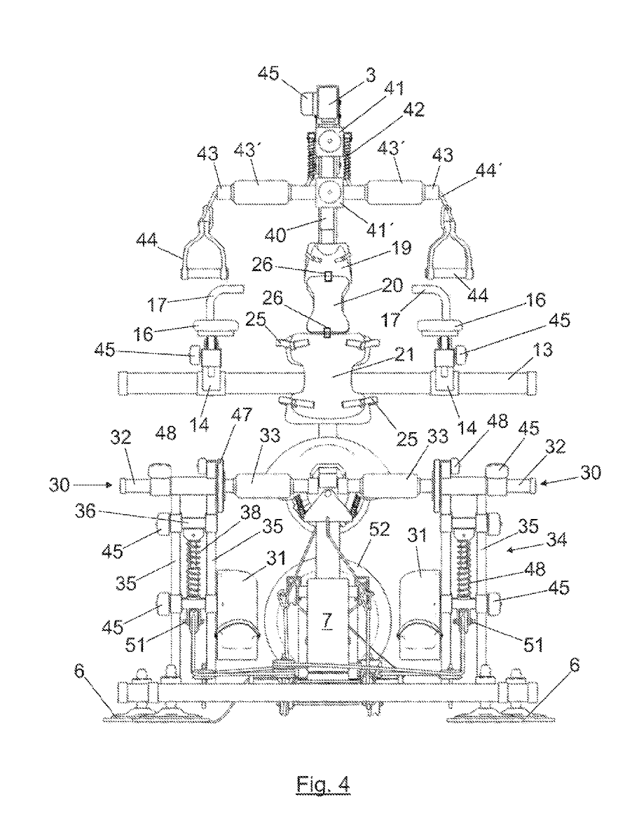

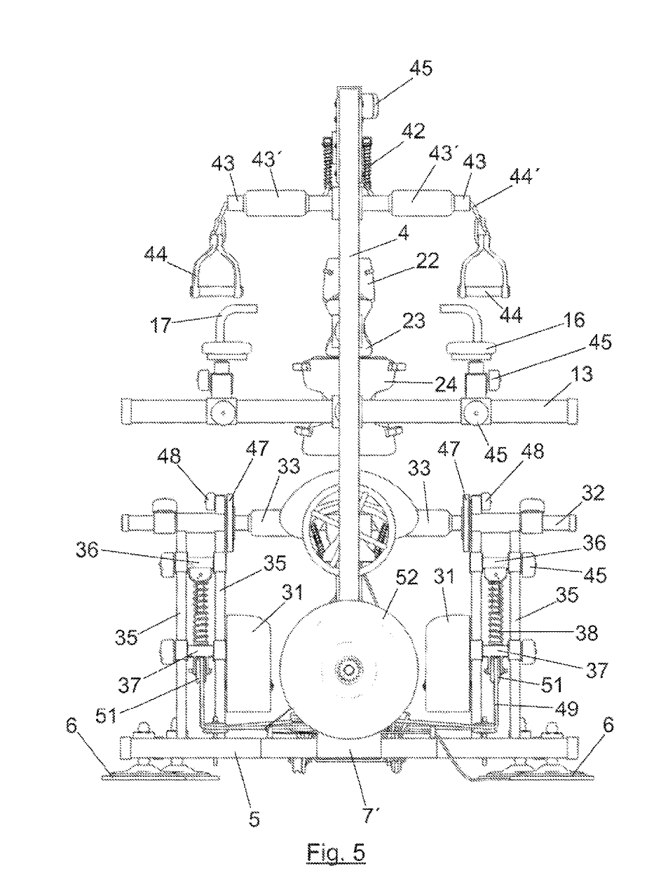

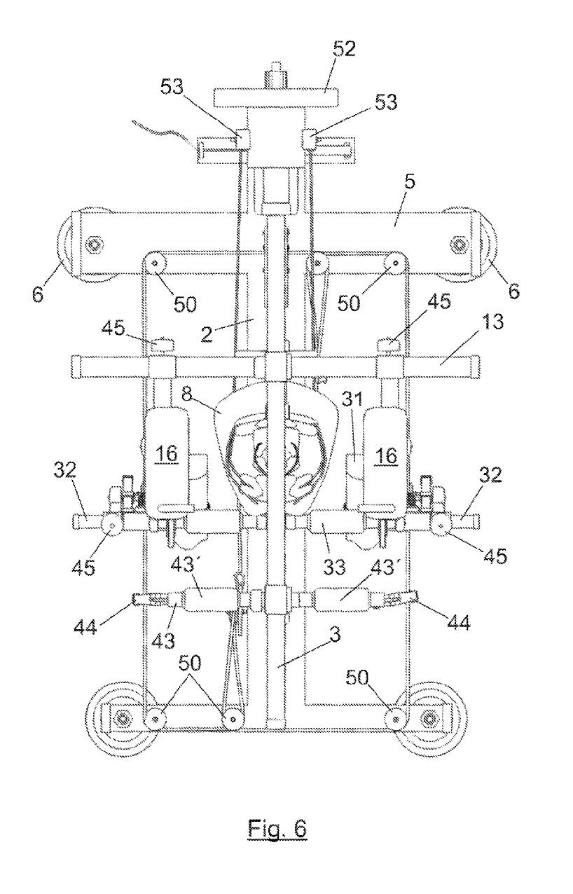

As can be seen in FIGS. 1 to 6, the piece of therapeutic and preventative equipment comprises a C-shaped support frame 1, with a lower horizontal stretch 2 and an upper horizontal stretch 3, the two being parallel to one another, in addition to an intermediate central stretch 4, which serves to link the lower 2 and upper 3 stretches together.

The lower stretch 2 has end crosswise extensions 5 provided with support feet 6 that define the support base of the assembly.

A vertical column 7 is mounted to the lower horizontal stretch 2, it being possible to adjust the height and position of the same along the length of said stretch 2, this column serving to support a seat 8 for the user or patient to be treated accordingly.

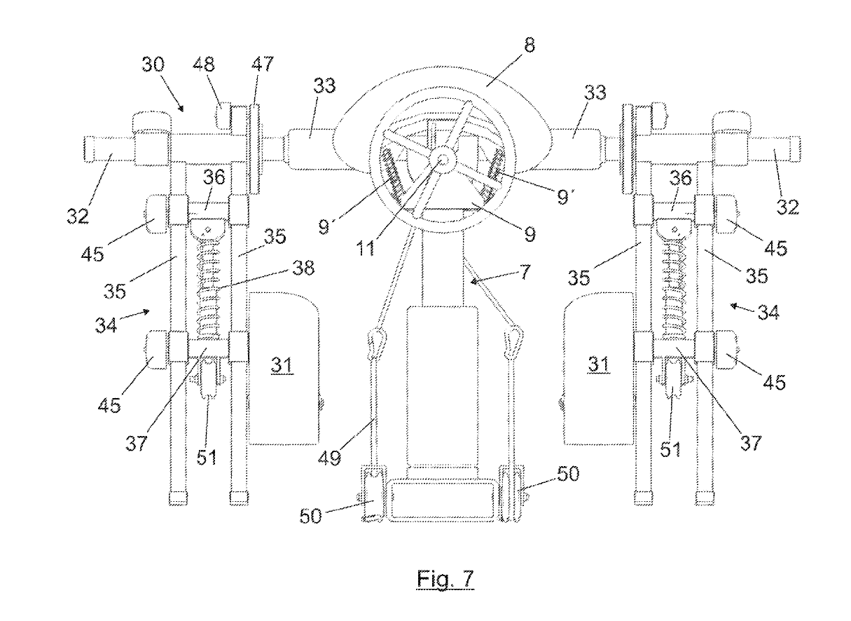

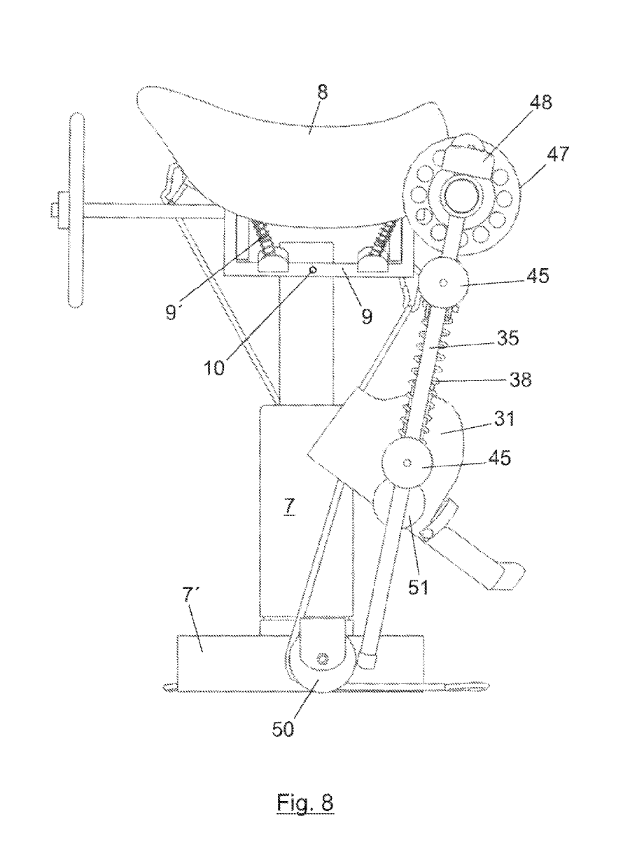

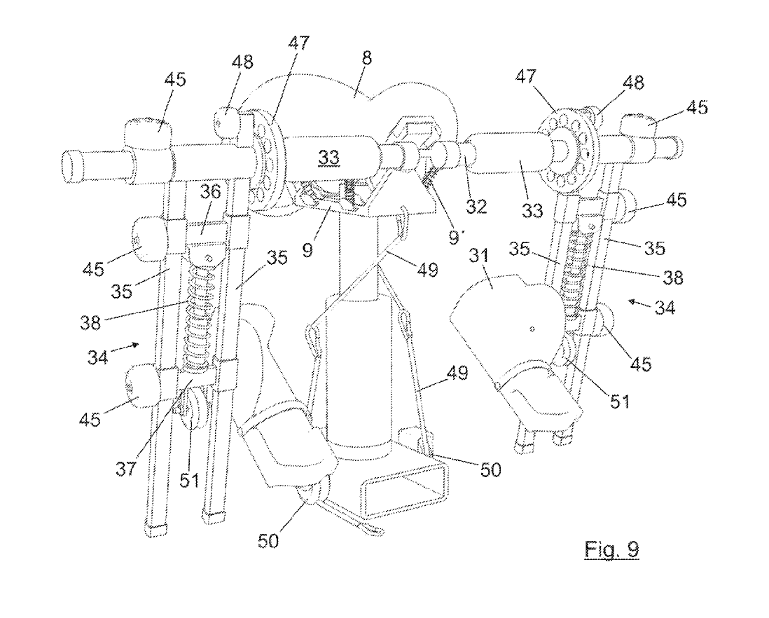

As can be seen more clearly in FIGS. 7, 8 and 9, the seat 8 may be mounted to the column 7 by means of a cart 9, which is linked to said column by means of a crosswise rotation shaft 10. The seat 8 is in turn linked to the cart 9 by means of a longitudinal rotation shaft 11 and elastic supports 9′, such that the seat 8 may tilt on the shafts 10 and 11, which are perpendicular to one another. The seat 8 may furthermore be moved along the length of the longitudinal rotation shaft 11 and is equipped with position locking means that serve to lock the seat at the selected angle.

The seat 8, which is preferably saddle shaped, may move in all directions. These movements may furthermore be selected to be made in one single direction (front to back, side to side and/or in a circle).

A first auxiliary column 12 is suspended from the horizontal stretch 3 of the frame, as shown in FIGS. 1 to 3, 10 and 11, the position of which may be adjusted along the length of said stretch 3. A horizontal profile 13 is mounted to this auxiliary column 12, the position of which may also be adjusted along the height of the auxiliary column 12. In turn, two front arms 14 are mounted to the horizontal profile 13 perpendicularly to the same, each one of which is located at one side of the auxiliary column 12, it being possible to adjust the position of these arms along the length of the horizontal profile 13. Each arm has a cart 15 mounted to it, these carts serving to bear an armrest 16 with a front handle 17. The position of the carts 15 may be adjusted along the length of the arms 14, the carts being linked to said arms by means of elastic supports made up of springs 18 and locking means 18′.

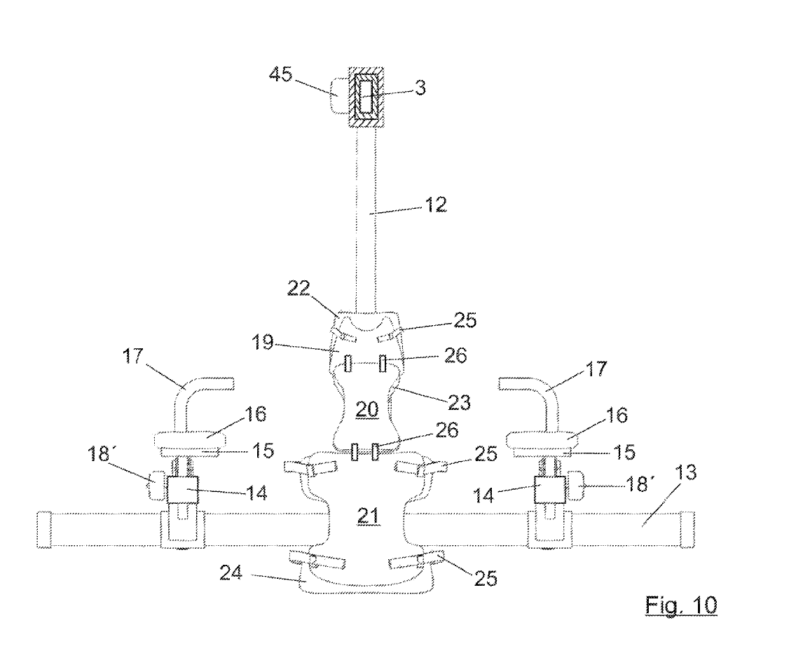

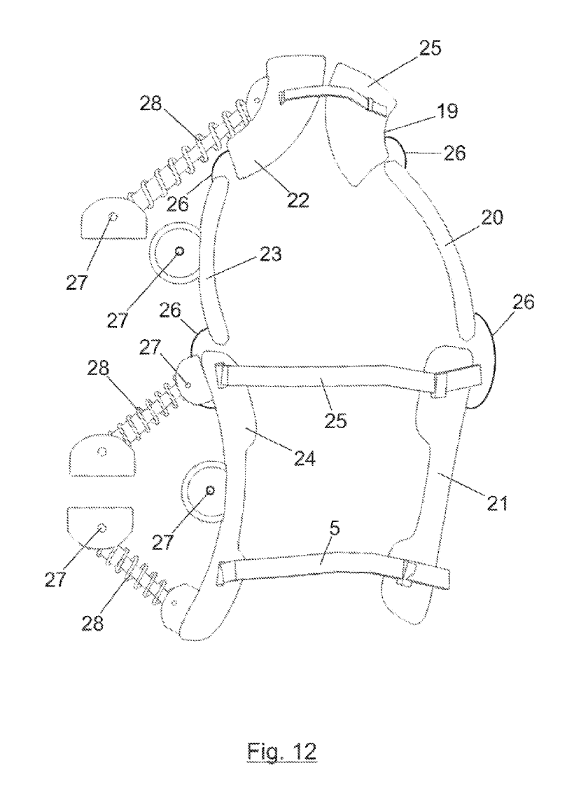

As can be seen more clearly in FIGS. 10 to 12, the auxiliary column 12 also bears means for controlling the posture of the body and spinal column, these means being made up of three frontal segments, referenced with numbers 19, 20 and 21 and three rear segments, referenced with numbers 22, 23 and 24, these frontal and rear segments being arranged opposite one another and linked to one another by means of adjustable elastic fastening means, which may constitute elastic straps 25, for example. The three frontal segments and three rear segments are also linked to one another by means of elastic straps 26. The rear segments 22 and 23 are fastened to the auxiliary column 12 and horizontal profile 13 by means of horizontal joints 27, elastic supports 28 and supports 29.

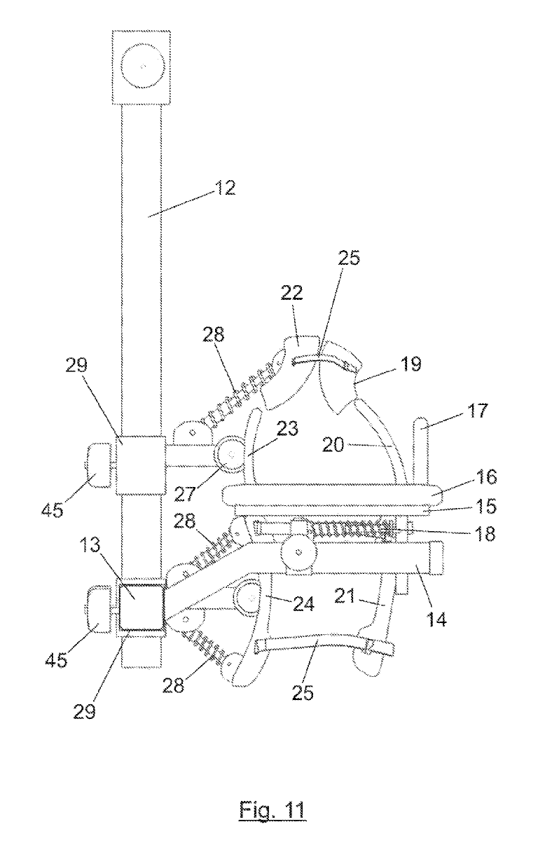

The three rear segments 22, 23 and 24 and the three frontal segments 19, 20 and 21 are grouped into pairs: one upper pair consisting of segments 19 and 22, intended to be coupled to the neck; one central pair made up of frontal segment 20 and rear segment 23, intended to be coupled to the back and thorax area and a lower pair, made up of frontal segment 21 and rear segment 24, intended to be coupled to the abdomen and lumbar areas of the patient or equipment user. The lower segments 24 are furthermore linked to the auxiliary column 12 by means of a support 29, as shown in FIG. 11.

As can be seen more clearly in FIGS. 7 to 9, adjustable support means for the legs and feet are also arranged on the cart 9 supporting the seat 8. These means include two upper horizontal supports 30, which are aligned and each one of which is arranged at one side of the seat 8 in order to support the legs and two lower foot rests 31, which may be tilted and the position of which may be adjusted, are furthermore suspended from several other aligned horizontal bars 32, which form part of the supports 30. Each one of these bars 32 bears a pillow 33 used to support the legs, in addition to a flat lower support structure 34, which tilts around the bar 32 and is made up of two parallel vertical bars 35, between which two rungs 36 and 37 are mounted, it being possible to move the same along the length of the vertical bars 35. The upper 36 and lower 37 rungs are provided with fastening means in order to be fastened to the vertical bars 35 and are linked to one another via elastic suspension means, consisting of a spring 38, for example. The footrests 31 are mounted to the lower rung 37, it being possible for these foot rests to tilt easily on the same.

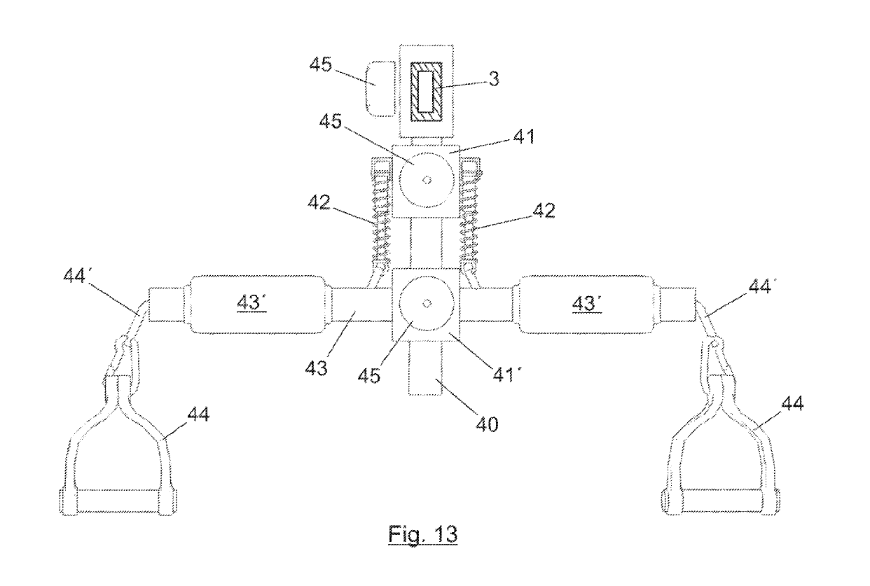

A second auxiliary column 40 is furthermore suspended from the upper horizontal stretch 3 of the frame 1 as shown in FIGS. 1 to 4 and 13, it being possible to adjust the position of this column along the length of said stretch and to which two head-pieces 41-41′ that may be adjusted in height are mounted, the same being linked to one another by means of springs 42. The lower headpiece 41′ bears a crossbar 43 with pillows 43′ for supporting the arms. Both handles 44 are hung from the ends of the crossbar by means of ropes 44′, the length of which may be adjusted elastically.

According to the representations provided in the drawings, all of the mobile components, for example in the upper stretch 3 of the frame, in the auxiliary column 12 and on the horizontal profile, etc., are mounted in a sliding manner, using a screw or locking nut 45.

The column 7 supporting the seat 8 may be adjusted in height and is mounted by means of a base 7′ on the lower stretch 2 of the frame.

The lower support structures made up of the vertical bars 35 shown in FIGS. 7 to 9 can tilt on the horizontal bars 32 and may be locked in a certain position or at a certain angle using the flywheels 47 and pin 48.

Finally, the equipment described has a closed force-transmission circuit made up of a flexible rope, chain or cable 49, the ends of which are fastened to the seat 8 and run over the pulleys 50 joined to the frame and pulleys 51 mounted to the flat lower support structure made up of the vertical bars 35. This force transmission circuit may furthermore include an inertia flywheel 52, the shaft of which is located on the plane defined by the support frame and which serves to bear a pulley 53 through which the cable or rope 49 passes.

All of the elements supported or mounted to the piece of equipment capable of rotating would be provided with locking means to fix them in place and guarantee any position selected on said element. These means may consist of screws or locking nuts 45.

Likewise, all of the components that may be adjusted in position along the length of the column, profile or similar would also be provided with locking means, which may equally constitute screws or locking nuts 45.

The supports or elastic means that serve to support or are linked to mobile components may consist of mechanical or pneumatic springs, etc.

In the piece of equipment described, once the patient has selected their position in the device seat, the segments or orthoses are placed on their core, the same including back, lumbar, abdominal, thoracic and neck segments, which are located on both the front and rear portions of the same, in the latter case being moulded at the upper portion for the occipital region. The user's feet are located on pedals, which in turn may move or be locked in a selected position.

When the seat 8 moves, the closed force-transmission circuit 49 is activated and continuous movement is induced using the surrounding energy accumulated in said circuit, which may or may not incorporate an inertia mechanism, such as the inertia flywheel 52. Upon flexing/extending the knee by pushing the pedals 31, movement of the pelvic tilt is facilitated, which sequentially induces movement in the spinal column, the same being controlled at the desired axis via the orthoses (segments 19 to 24) in the desired positions. Just like the orthoses, the support arm for the pedals has a number of springs, whether mechanical or pneumatic and/or elastic connections, which serve to provide resistance a posteriori, in order to free the energy induced in the same via the movement, just like the springs in the orthoses located along entire length of the device.

Moreover, there are armrests 16 with a spring system 18 and grips 20, which make it possible to push the arms forwards, thereby facilitating the cat movement (kyphosis/lordosis) along the length of the column as a continuous resistance and push mechanism to facilitate articular movement and muscular activation.

There is also a complementary crossbar 43 in the upper portion of the piece of equipment, which serves as a grip should it be necessary to gather synergistic strength to contract muscles in the rest of the body, in order to achieve movement of the spinal column, whilst meanwhile facilitating bidirectional traction when the arms contract caudally and the feet exert a knee extension movement on the pedals in order to induce kyphosis in the spinal column, thus improving stretches in soft tissues, particularly overall neurodynamic stretches. This crossbar 43 has a number of grips 44 with extendible elastic ropes 44′ and springs 42 that serve to facilitate strength work and help to gather energy when the flow force is no longer used.

The seat 8 positions may vary on different planes owing to the multi-articular design of the different segments in the device and given the ability to move with the condition and/or the pre-established aims to maintain optimal segmentational physical state.

Below, possible uses and advantages of the piece of equipment object of the invention are set out:
Neurodynamic mobilisation of the locomotor apparatus.
It contributes towards activating muscles, tendons and ligaments and towards capsular activation, thereby improving overall articular physiology and articular physiology in specific segments.
It is capable of stretching soft tissues.
Alongside compression and distraction forces in specific segments, micro-movements in segments activate progressive segmental disc hydration.
It has the potential to prove effective in combatting soft tissue fibrosis, pre and post-surgery/injury, in addition to preventing said fibrosis from developing (see for example post-surgical fibrosis after laminectomies and foraminotomy in disc herniation operations).
It contributes towards segmental and overall proprioceptive re-adaptation of the body in an overall kinetic chain as of cumulative segmental movements of the core, pelvis and extremities.
It contributes towards lumbopelvic stabilisation and improves the strength of pelvic floor muscles with regular training.
It is capable of inducing activation of the locomotor apparatus in postures and positions the body permits, either given its deficiencies or positions that produce pain/relief, in addition to positions selected by professionals in the health and/or physical activity sciences field, and furthermore the indications of preventative services for improving deficiencies, so as to prevent future injury when working.

1. Equipment for treating and caring for the spinal column by means of the structural and functional conditioning of segments through movement in selected postures, wherein it comprises a support frame, a seat for the patient, the position of which may be oriented and adjusted, means for controlling the posture of the body and spinal column, adjustable support means for the feet and legs, traction/distraction means and adjustable support means for the arms, in addition to a force-transmission circuit, made up of flexible rope, chain or cable, which links the frame, seat and controlled support means for the feet and legs through two-way support pulleys; said support frame being C-shaped with a central vertical stretch, an upper horizontal stretch from which the means for controlling the posture of the body and spinal column, the traction/distraction means and adjustable arm support means are suspended and a lower horizontal stretch, which is parallel to the upper stretch and to which a vertical column that supports the seat and adjustable support means for the legs and feet are mounted; said means for controlling the posture of the body and spinal column being made up of the frontal segments and rear segments, which make up an adjustable corset that can be adapted to the patient's core and said adjustable feet and support means for the legs and feet comprising two upper horizontal supports, which are aligned, serve to support the legs and are mounted to the column supporting the seat, in addition to two lower foot rests, the position of which may be adjusted and which are suspended from the upper supports; with the aforementioned traction/distraction and arm support means consisting of an upper crossbar bearing adjustable end handles and two lower arm rests, the position of which may also be adjusted and which have a front grip.

2. The equipment according to claim 1, wherein the lower support structure includes a first auxiliary column, which is suspended from the upper horizontal stretch and the position of which may be adjusted along the length of said stretch, the lower arm rests and segments that make up the corset being mounted to said first column, the same being easy to adjust in height.

3. The equipment according to claim 1, wherein the means for controlling the posture of the body and the spinal column comprise three rear segments and three frontal segments, the same being opposite one another and linked by means of adjustable elastic fastening means, where the rear segments are fastened by means of horizontal joints and elastic supports to supports mounted to the first auxiliary column.

4. The equipment according to claim 3, wherein the three rear segments and three front segments are grouped into pairs, with one upper pair to be coupled to the neck, one central pair to be coupled to the back and thorax area and one lower pair to be coupled to the abdomen and lumbar area, the two segments in the lower pair being linked to the seat by means of elastic elements.

5. The equipment according to claim 2, characterised in a horizontal profile that is easy to adjust in height is mounted to the first auxiliary column in a crosswise direction, the arm rests, which may be moved along the length of said profile, being mounted to the same.

6. The equipment according to claim 1, wherein the upper crossbar is suspended from the upper horizontal stretch of the frame by means of a second auxiliary column, the position of which may be adjusted along the length of said stretch and to which two head-pieces adjustable in height are mounted, the same being linked to one another, where the lower head-piece serves to bear the crossbar, from the ends of which the end handles are suspended by means of ropes that may be adjusted elastically in length.

7. The equipment according to claim 1, wherein the lower horizontal stretch of the lower support structure is equipped with crosswise end extensions, which are in turn provided with support feet.

8. The equipment according to claim 1, wherein the column supporting the seat is adjustable in height and mounted to the lower horizontal stretch of the lower support structure by means of a base, the position of which may be adjusted along the length of said stretch.

9. The equipment according to claim 8, wherein the seat is mounted to the column by means of a cart, which includes two perpendicular joint shafts, one of which is longitudinal and the other transversal, which serve to determine the orientation of the seat, in addition to means for adjusting and locking said seat into position.

10. The equipment according to claim 9, wherein the cart supporting the seat is mounted to the vertical column by means of a ball joint, which makes it possible to tilt the seat in any direction and includes means for adjusting tilt resistance and means for locking the ball joint in any position selected on the cart.

11. The equipment according to claim 1, wherein the horizontal profile serves to bear two front arms, one of which is located on each side of the first auxiliary column and it being possible to adjust the position of the same along the length of said horizontal profile, there being a cart mounted to each one of the arms, serving to bear an arm rest, it being possible to adjust the position of these carts along the length of the arms and the arm rests being linked to the carts by means of elastic supports.

12. The equipment according to claim 1, wherein the upper horizontal supports consist of other such horizontal bars, which are aligned and mounted to the front portion of the cart supporting the seat, each one of these bars serving to bear a pillow in order to support a leg and a lower flat support structure, which can tilt around the bar, to which two rungs are mounted, it being possible for the same to travel along the height of the lower support structure and the same being provided with fastening nuts for fastening to the lower support structure and being linked to one another by means of elastic suspension means, with the lower rung having a foot rest mounted to it by means of a horizontal tilt shaft.

13. The equipment according to claim 1, wherein the force-transmission circuit is made up of a flexible rope, cable or chain, the ends of which are fastened to the seat and are driven over free rotation pulleys mounted to the lower support structure and foot rest.

14. The equipment according to claim 13, wherein the force-transmission circuit includes an inertia flywheel, which can rotate freely, the axis of which is located on the plane defined by the support frame and which serves to bear a pulley (53) through which the cable of said circuit passes.

15. The equipment according to claim 12, wherein the upper supports are equipped with locking means for locking the flat lower support structures to the horizontal bars to which they are mounted.
